(19) United States
(12) Patent Application Publication
(10) Pub. No.: US 2025/0094764 A1
(43) Pub. Date: Mar. 20, 2025

(54) TRAINING A SUPPORT BOT WITH SOURCE CODE

(71) Applicant: Boomi, LP, Conshohocken, PA (US)

(72) Inventors: Michael J. Hudson, Delray Beach, FL (US); Kaushal Bhati, Gujarat (IN)

(21) Appl. No.: 18/368,767

(22) Filed: Sep. 15, 2023

(51) Int. Cl. G06N 3/006

(52) U.S. Cl. CPC G06N 3/006

(57) ABSTRACT

Benefits can be obtained from utilizing artificial intelligence (AI) for customer support. However, when the customer support is for a software application, conventional AI-based support bots rely on non-authoritative data sources, rather than the underlying computer code of the software application. While artificial intelligence has been applied to source code, the focus is on the structure of the programming language, rather than what the computer code does or how it works. Accordingly, an AI model is disclosed that can be trained on source code to provide responses about what a software application does, how it works, and/or the like. In an embodiment, source objects implement an AI-supporting interface that can support the AI model in the training and/or operating phases.

### BACKGROUND

### Field of the Invention

The embodiments described herein are generally directed to artificial intelligence, and, more particularly, to training a support bot for a software application using the source code of that software application.

### Description of the Related Art

Customer support has been a popular application of artificial intelligence (AI). In this context, the artificial intelligence is programmed to respond to customer queries or other requests, and simulate a human response using natural language processing (NLP). Such use of artificial intelligence can improve the customer-support process with fast, consistent responses and reduced human error.

There have been a number of recent breakthroughs in natural language processing, and particularly, in generative AI models. In particular, one architecture that has proven successful in generative AI for natural language processing is the transformer architecture. The transformer architecture comprises a deep-learning neural network that relies on a multi-head attention mechanism. Some well-known examples of transformers include the generative pre-trained transformer (GPT) series, introduced by OpenAI of San Francisco, California. Each of the GPT series of models comprises a large language model.

In the context of customer support, an AI model may be trained using structured and/or unstructured data which have been extracted from text documents, audio, video, databases, or other data sources related to the product being supported. However, when the product is a software application, these data sources are, by their nature, non-authoritative. In particular, these data sources merely represent what someone has said about how the software application works, and may or may not be reliable. In contrast, the underlying computer code that implements a software application is the most authoritative data source possible. The computer code is always reliable and accurate, even with respect to bugs and undocumented features of the software application.

Thus, in the context of customer support for software products, it would be advantageous to be able to train an AI model directly on the computer code, such as the source code of the software application being supported. This would allow the AI model to generate reliable and authoritative natural-language responses to user requests about the software.

However, in practice, it has proven difficult to train artificial intelligence on computer code. The artificial intelligence tends to focus on the structure of the programming language itself, instead of the capabilities of the software application implemented by the computer code. An example is the advanced integrated development environment (IDE), described in “ML-Enhanced Code Completion Improves Developer Productivity,” by M. Tabachnyk et al., Jul. 26, 2022, which uses transformer-based, hybrid semantic machine learning to produce suggestions for completing source code. While this integrated development environment is able to construct source code, it is not able to analyze and describe what the computer code does or how it works.

### SUMMARY

Accordingly, systems, methods, and non-transitory computer-readable media are disclosed for training a support bot for a software application using the source code of that software application.

In an embodiment, a method comprises using at least one hardware processor to: during a training phase, train an artificial intelligence (AI) model on a training dataset, wherein the training dataset comprises source code for one or more source objects of a software application, wherein at least one of the one or more source objects implements an AI-supporting interface, and wherein the training detects when any of the one or more source objects implements the AI-supporting interface; deploy the trained AI model in a support bot for the software application; and during an operating phase, receive one or more user requests, related to the software application, via a chat interface, and for each of the one or more user requests, input the user request to the AI model to produce a response from the AI model, wherein the response is based on an output of one or more functions of the AI-supporting interface of the at least one source object, and output the response via the chat interface. The software application may comprise an integration process or an element within an integration process.

The one or more functions of the AI-supporting interface may comprise a query function that receives a set of one or more keywords as input, and returns response data. The response data may comprise a natural-language response string. The one or more functions of the AI-supporting interface may comprise a keyword function that returns a list of keywords. The query function may generate different response data for different permutations of keywords in the list of keywords. During the operating phase, the AI model may, for at least one of the one or more user requests: call the keyword function to acquire the list of keywords; determine a query comprising one or more keywords in the list of keywords; and call the query function, using the query as the input to the query function, to acquire the response data; wherein the response is based on the response data. During the training phase, the training may: call the keyword function to acquire the list of keywords; and for each possible permutation of one or more keywords in the list of keywords, call the query function, using the permutation as the input to the query function, to acquire the response data, and store the response data; wherein the response is based on at least one of the stored response data.

During the operating phase, for each of the one or more requests, the AI model may: receive the user request; derive a set of one or more keywords from the user request; identify one or more contexts based on the set of one or more keywords; identify one or more data sources associated with the identified one or more contexts, wherein the one or more data sources comprise the at least one source object; retrieve response data from each of the one or more data sources, wherein the retrieved response data comprise the output of the one or more functions of the AI-supporting interface of the at least one source object; and determine the response based on the retrieved response data. The AI model may comprise a control process that receives the user request, derives the set of one or more keywords, identifies the one or more contexts, identifies the one or more data sources, and determines the response. The control process, for each of the one or more data sources, may spawn a worker process to retrieve the response data from that data source, and return the retrieved response data to the control process.

Retrieving the response data from each of the one or more data sources may comprise, for each of the one or more data sources: determining whether or not the data source is a source object; when determining that the data source is a source object, determining whether or not that source object implements the AI-supporting interface; when determining that the data source is not a source object or does not implement the AI-supporting interface, retrieving the response data according to a first process; and when determining that the data source is a source object and does implement the AI-supporting interface, retrieving the response data according to a second process that is different from the first process. The second process may comprise: calling a keyword function of the AI-supporting interface to acquire a list of keywords; determining a query based on the list of keywords acquired from the keyword function and the set of one or more keywords derived from the user request; and calling a query function of the AI-supporting interface, using the query as input to the query function, to acquire the response data.

During the training phase, for each source object that implements the AI-supporting interface, the training may comprise calling a keyword function of the AI-supporting interface to acquire a list of keywords, and for each possible permutation of one or more keywords in the list of keywords, calling a query function, using the permutation as the input to the query function, to acquire response data, and storing the response data in association with the permutation. During the operating phase, the second process may comprise determining a permutation that matches the set of one or more keywords derived from the user request, and retrieving the response data associated with that permutation.

The user request and the response may be expressed in natural language. The training may comprise unsupervised learning. The unsupervised learning may comprise clustering data sources, including the source code for the one or more source objects, into groups. The training may further comprise associating each of the groups with a respective context. Each respective context may comprise one or more keywords.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure in which one or more of the processes described herein may be implemented, according to an embodiment;

FIG. 2 illustrates an example training process for training a support bot for a software application, in a training phase, using the source code of the software application, according to an embodiment;

FIG. 3 illustrates an example operating process for operating a support bot for a software application, in an operating phase, according to an embodiment;

FIG. 4 illustrates an AI model, according to an embodiment; and

FIG. 5 illustrates an example processing system, by which one or more of the processes described herein may be executed, according to an embodiment.

### DETAILED DESCRIPTION

In an embodiment, systems, methods, and non-transitory computer-readable media are disclosed for training a support bot for a software application using the source code of that software application. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Example Infrastructure

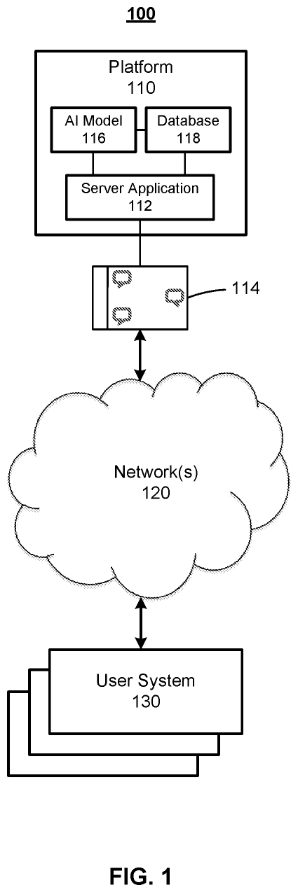

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120, to which one or more user systems 130 are also communicatively connected. Network(s) 120 enable communication between platform 110 and user system(s) 130. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 through a single set of network(s) 120, it should be understood that platform 110 may be connected to different user systems 130 via different sets of one or more networks. For example, platform 110 may be connected to a subset of user systems 130 via the Internet, but may be connected to another subset of user systems 130 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of a user of a software application, which is being supported by platform 110. Users of the software application will utilize their respective user systems 130 to obtain support information about the software application from platform 110. A user system 130 could also be the personal or professional workstation of an administrator of the support bot described herein. An administrative user may utilize a respect user system 130 to train, deploy, or otherwise manage the support bot, as well as other functions of platform 110.

Platform 110 may execute a server application 112, which may comprise one or more software modules implementing one or more of the disclosed processes. Server application 112 may provide customer support to users of one or more software applications being supported by platform 110. As part of this customer-support function, server application 112 may generate a user interface 114 (e.g., graphical user interface) that enables a user to interact with an AI model 116. In particular, server application 112 may implement a support bot that receives user requests, regarding the supported software application(s), through a chat interface in user interface 114. The support bot of server application 112 may provide each user request to AI model 116, which generates a response, and then output the response to the user through the chat interface within user interface 114. The chat interface may be a graphical user interface, in which case, user requests may be input and/or responses may be output as text, an audio user interface, in which case, user requests may be input and/or responses may be output as audio, an audiovisual user interface, in which case, user requests may be input and/or responses may be output as video with audio, and/or any other type of two-way user interface. Platform 110 may also manage a database 118, which may store data used by server application 112 and/or AI model 116.

The software application(s) that are being supported by server application 112 and platform 110 may comprise any type of software application. As one, non-limiting example, the software application may be an integration process, a component of an integration process, a data source for an integration process, a destination of an integration process, or the like. An integration process may represent a transaction involving the integration of data between two or more systems or trading partners (e.g., in Electronic Data Interchange (EDI)), and may comprise a series of elements (e.g., steps) that specify logic and transformation requirements for the data to be integrated. Each element may transform, route, and/or otherwise manipulate data to attain an end result from input data. For example, a basic integration process may receive data from one or more data sources (e.g., via an application programming interface), manipulate the received data in a specified manner (e.g., including analyzing, normalizing, altering, updated, enhancing, and/or augmenting the received data), and send the manipulated data to one or more specified destinations (e.g., via an application programming interface). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

The user of a user system 130 may authenticate with platform 110 using standard authentication means, to access the disclosed processes of server application 112, via user interface 114, in accordance with permissions or roles of the associated user account. Alternatively, the disclosed processes may be publicly available to any user of user system 130, via user interface 114, regardless of authentication. In either case, the user may interact with user interface 114 to submit user requests to AI model 116 and receive responses from AI model 116, via a support bot of server application 112. These user requests and responses may be expressed in natural language, such that the interaction mimics a human conversation. As used herein, the term “natural language” refers to the language that a human would use in a conversation with another human. For example, the user requests may comprise natural-language questions about capabilities, features, functions, bugs, compatibilities, troubleshooting, inputs, outputs, settings, and/or the like, for a supported software application (e.g., integration process). While the support bot will primarily be described herein as supporting users of the software application, it should be understood that the support bot could just as easily be used to support developers of the software application by, for example, providing insights into what particular software modules of the software application do, how they work, and/or the like, during development of the software application.

### 2. AI-Supporting Interface

In an embodiment, a software application to be supported by platform 110 may implement an AI-supporting interface. The software application (e.g., integration process) as a whole may implement the AI-supporting interface, and/or each of a plurality of software modules within the software application may implement individual AI-supporting interfaces. Not all of the software modules need to implement an AI-supporting interface, and the disclosed embodiments will work even if the software application implements no AI-supporting interfaces. For simplicity, a set of computer code on which AI model 116 is trained will be referred to herein as a “source object,” whether represented in source code, object code, byte code, machine code, or the like, and whether representing the entire software application or a portion (e.g., one or more software modules) of the software application, and whether representing an executable or a software library.

An example of the AI-supporting interface, having the arbitrary name SupportAI in this case, is provided below:

```
public interface SupportAI {
  public static String query(String[ ] keywords);
  public static String[ ] getKeywords( ) ;
}
```

The AI-supporting interface comprises two functions: a query function query( ), which receives a list of keywords as input, and returns response data, which may comprise or consist of a natural-language character string, as output; and a keyword function getKeywords( ), which returns a list of keywords as output. Notably, both functions are static, such that they can be called without instantiating the source object. It should be understood that the specific interface name and function names that are used are not important. However, for efficiency, the same AI-supporting interface should be used across all source objects. In other words, during development of the software application(s), a single, common AI-supporting interface should be made available for implementation in every source object. As a consequence, AI model 116 only needs to learn a single AI-supporting interface. Alternatively, AI model 116 could learn each of a plurality of different AI-supporting interfaces.

To provide a concrete example of an implementation of the AI-supporting interface SupportAI, the two component functions may be implemented as follows, in a source object SomeCode, for a trading partner profile used in elements of integration processes:

```
public class SomeCode implements SupportAI {
  public static String query (String[ ] keywords) {
    if(keywords.contains(“Optional”)) {
        if(keywords.contains(“ACKHDR”)) {
          return “ACKHDR is optional and will only be generated
          if the Application Reference is set”;
        }
        /*...additional logic branches for “Optional” keyword...*/
    }
    /*...additional logic branches for other keyword(s)...*/
  }
  public static String[ ] getKeywords( ) {
      return new String[ ]{“STX”, ”ACKHDR”, ”ANA”, ”BDS”,
      ”Specification”, “Default”, “Tradacoms”, “Optional”};
  }
}
```

During training of AI model 116, the source code of the source object SomeCode may be parsed by a training tool. In doing so, the training tool may detect the implementation of the AI-supporting interface SupportAI, for example, by searching for the name “SupportAI” and/or other relevant keywords or phrases (e.g., “implements”, “implements SupportAI”, “SomeCode implements SupportAI”, etc.). It should be understood that this search may be represented as a regular expression.

In a first embodiment, when detecting that the source object SomeCode implements the AI-supporting interface SupportAI, the training tool may flag the source object SomeCode, using a parameter (e.g., Boolean parameter), as implementing the AI-supporting interface SupportAI. Thus, when AI model 116 encounters the source object SomeCode during the operating phase, AI model 116 will know, based on the parameter, that the source object SomeCode implements the AI-supporting interface SupportAI. Based on this knowledge, AI model 116 may call one or more of the functions in the AI-supporting interface, implemented by the source code SomeCode, to obtain response data. For example, AI model 116 may call the keyword function to acquire a list of keywords, determine a query comprising one or more keywords in the list of keywords, and call the query function, using the query as the input to the query function, to acquire the response data. This first embodiment above has the advantage of being dynamic. In particular, any changes to the implementation of the AI-supporting interface SupportAI will be immediately reflected in AI model 116, even after AI model 116 has been trained (i.e., during the operating phase). In other words, AI model 116 does not have to be retrained on new implementations of previously learned AI-supporting interfaces.

In an alternative second embodiment, when detecting that the source object SomeCode implements the AI-supporting interface SupportAI, the training tool may call one or more of the functions in the AI-supporting interface to obtain the response data. For example, the training process may call the keyword function to acquire the list of keywords, and, for each possible permutation of one or more keywords in the list of keywords, call the query function, using the keyword permutation as the input to the query function, to acquire the response data, and store the response data, in association with the keyword permutation, for use by AI model 116. Subsequently, during the operating phase, AI model 116 may retrieve the response data for a particular permutation of keywords that matches one or more keywords in a user request, and use the retrieved response data to produce a response. This second embodiment has the advantage of being simpler to implement in the operating phase. In particular, AI model 116 does not have to have access to the source objects during the operating phase, since all possible response data from the AI-supporting interface of every source object have already been acquired and stored in the training phase.

During training of AI model 116, one or more, including potentially all, of the keywords in the return string of getkeywords( ) may be associated, in the first embodiment above, with the SomeCode source object, or in the second embodiment above, with the pre-acquired response data returned by query( ). In addition, one or more other keywords could be associated with the SomeCode source object or pre-acquired response data. These other keyword(s) may be acquired from comments or other annotations in the SomeCode source object or in any conventional means. As a result, the SomeCode source object or pre-acquired response data will be associated with a set of one or more keywords, which may comprise a mixture of the keywords in the list returned by getKeywords( ), keywords extracted from annotations, and/or keywords acquired by other means. This set of keyword(s) represents the context of the SomeCode source object, and may be stored in association with the SomeCode source object. In addition, this context may be indexed by each keyword in the set of keyword(s) representing that context for easy retrieval. It should be understood that similar contexts can be built for other data sources (e.g., text documents, databases, images, video, etc.).

During the operating phase, AI model 116 may extract or otherwise derive a set of one or more keywords from a user request. Some keywords may be parsed directly from the user request, whereas other keywords may be derived indirectly or inferred based on keywords in the user request. In this latter case, AI model 116 may derive one or more synonyms for each of one or more keywords or phrases in the user request. A synonym may be any word or phrase that has the same or similar meaning (i.e., semantically similar). Synonyms may be looked up using a thesaurus or using word embeddings. Word embeddings, which may be derived from language modeling and feature learning, map words and phrases to vectors of real numbers. In this case, each synonym of a target word or phrase can be easily derived as a word or phrase whose vector is close to the vector of the target word or phrase (e.g., in terms of Euclidean or other distance between their respective vectors).

Having derived a set of keyword(s) from the user request, AI model 116 may then compare the set of keyword(s) to the contexts to identify one or more matching contexts. This matching may be performed using any suitable one or more criteria (e.g., percentage or number of keywords matched or other type of confidence scoring). Each context is associated with one or more data sources, which may include one or more source objects. Thus, AI model 116 may retrieve or otherwise identify any data sources associated with each identified context. In this manner, AI model 116 may associate keywords, derived from a user request, with the SomeCode source object.

In the first embodiment, AI model 116 may call SomeCode.getKeywords( ) to retrieve the entire list of keywords associated with the source object SomeCode. Based on the set of keyword(s) derived from the user request and the entire list of keywords returned by SomeCode.getKeywords( ), AI model 116 can determine whether or not the source object SomeCode is relevant to the user request. Relevance may be determined using any suitable one or more criteria (e.g., percentage or number of keywords matched or other type of confidence scoring). When determining that the source object SomeCode is relevant, AI model 116 may call SomeCode.query( ) with the keyword(s) from the user request, to obtain the response data.

For example, in the above example, if SomeCode.query({“Optional”, “ACKHDR”}) is called, query( ) will execute the logic to return the response “ACKHDR is optional and will only be generated if the Application Reference is set”. It should be understood that this is a simple example in which a hard-coded string is returned as the response data. In an alternative implementation, the logic in query( ) may be more complex. For example, the logic may retrieve the response data from database 118 (e.g., in which case the response data may be modified without having to recompile the source object SomeCode), build the response data, portion by portion (e.g., from hard-coded strings or by retrieving each portion from database 118), and/or in any other suitable manner, based on the keywords that are passed as input. Regardless of how the response data are generated, the response data may represent information about the source object (e.g., what the source object does or knows, how the source object works, what the source object needs or does not need, how to configure the source object, etc.).

In the second embodiment, AI model 116 can retrieve the response data previously acquired during the training phase. For example, instead of the source object SomeCode itself being associated with the identified context, the response data for each permutation of keywords that was used in the training phase may be associated with the identified context. Based on the set of keyword(s) derived from the user request and the permutation(s) of keywords, AI model 116 may determine which permutation(s) of keywords are relevant to the user request. Relevance may be determined using any suitable one or more criteria (e.g., percentage or number of keywords matched or other type of confidence scoring). When determining that a permutation of keywords is relevant, AI model 116 may retrieve and return the response data that were previously returned by SomeCode.query( ), during the training phase, for that permutation of keywords.

The response data, returned by the AI-supporting interface and other data sources, is primarily exemplified herein as plain text (e.g., a natural-language character string). However, it should be understood that this is not a requirement. Rather, the response data, returned by one or more implementations of the AI-supporting interface and/or any one or more other data sources, may comprise rich text (e.g., formatted or otherwise structured text), documents, links (e.g., hyperlinks to websites) or other external references, unstructured data, such as media (e.g., images, audio, video, etc.), and/or any other type of data.

AI model 116 may determine a final response to return, in response to the user request, based on all of the response data that are collected from the AI-supporting interface implemented by one or more source objects, as well as from other data sources. For example, assume the user request is:
I am sending data to a trading partner via Tradacoms, but the STX segment in the output is missing the ‘ACKHDR’. Is this expected or a defect?
   In this case, AI model 116 may determine the relevance of the source object SomeCode based on the keywords “Tradacoms,” “STX,” “ACKHDR,” and “missing” (e.g., which may be determined to be a synonym of the keyword “optional”). AI model 116 may then return, as the final response:
The ACKHDR is defined as optional in the specification, so it is not set by default. However, setting the Application Reference will generate the ACKHDR.
   While this response is based on the response data returned by SomeCode.query( ), it does not consist of that response data. In other words, the AI-supporting interface aids AI model 116, but, in an embodiment, is not itself determinative of the final response. In an alternative embodiment, AI model 116 may select a single verbatim instance of response data, from among all response data that are returned by all data sources, as the final response. In this case, the final response may be identical to the selected response data.

In an alternative embodiment, instead of implementing an AI-supporting interface in each source object, annotations can be added within the comments in the source code of source objects. To aid AI model 116, these annotations may follow a particular format that is easy to identify (e.g., via regular expression) and/or parse. During training, the annotations may be ingested, along with the other source code, to determine the context (e.g., set of keywords) applicable to the source object. However, this alternative embodiment may not perform as well, since comments often become outdated during develop and frequently include errors. Thus, outdated and/or erroneous information may get propagated into AI model 116. In a hybrid embodiment, these annotations may be used in addition to an AI-supporting interface to determine the contexts for source objects.

### 3. Training Process

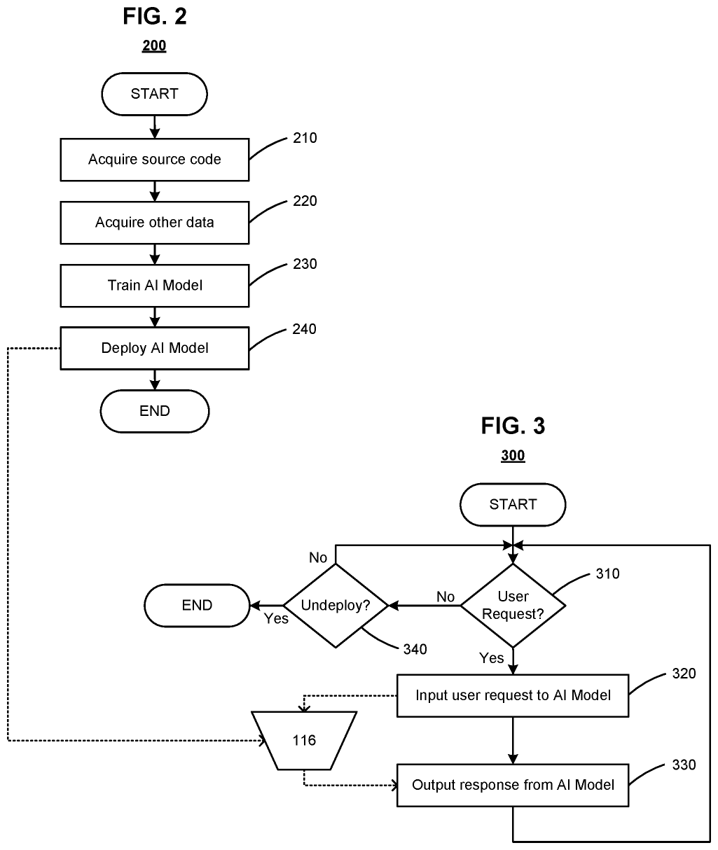

FIG. 2 illustrates an example training process 200 for training a support bot for a software application, in a training phase, using the source code of the software application, according to an embodiment. Training process 200 may be implemented by a training tool of server application 112 to train an AI model 116, which is then used by the support bot of server application 112. It should be understood that training process 200 may be used to train an AI model 116 for each software application that is supported by platform 110. In other words, each software application may be supported by a separate and distinct AI model 116. Alternatively, a plurality of software applications may be supported by the same AI model 116.

While training process 200 is illustrated with a certain arrangement and ordering of subprocesses, training process 200 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In subprocess 210, source code for the software application(s), being supported by platform 110, is acquired. It is assumed that platform 110 will have access to the source code. In an embodiment, platform 110 may itself be a development platform on which the software application(s) are developed, distributed, and/or hosted. For example, platform 110 may be an integration platform or provide integration platform as a service (iPaaS), which stores the source code for integration processes. Alternatively, the source code may be uploaded or otherwise provided to platform 110 by an administrative user via a user system 130. In either case, the source code may comprise one or more, and generally a plurality of, source objects that implement the AI-supporting interface described elsewhere herein.

In subprocess 220, other data sources related to the software application(s), being supported by platform 110, may be acquired. The other data sources may comprise structured data, such as text documents, relational databases, and/or the like, and/or unstructured data, such as audio, images, video, and/or the like. These other data sources may include user manuals, training manuals, software specifications, software schemas, training videos, diagrams, tutorials, document libraries, and/or the like, and be of the type generally used for customer support of a software application. It should be understood that these other data sources may also be available, in their raw forms, via user interface 114 in a manner that is typical for support sites. In an embodiment, training process 200 ingests all of these conventionally available data sources that are used to support software application(s), in addition to the source code for the supported software application(s).

In subprocess 230, AI model 116 may be trained on a training dataset that comprises the source code, acquired in subprocess 210, and the other data sources, acquired in subprocess 220. AI model 116 may be trained using unsupervised learning. In particular, the data sources in the training dataset may be clustered (e.g., using a clustering method) or associated (e.g., using an association rule) into groups according to similarities and differences between the data sources. For example, data sources may be grouped according to methods, variables, properties, data repository, class names, and/or the like to which the data sources pertain. Any suitable unsupervised learning algorithm may be used, including, without limitation, k-means clustering, k-nearest neighbors (KNN), hierarchical clustering, anomaly detection, artificial neural networks, principle component analysis, independent component analysis, the a priori algorithm, singular value decomposition, and/or the like.

Once the data sources have been clustered into groups, each group of data sources may be associated with a context. Each context may comprise a set of one or more keywords. Thus, keywords in a user request can be matched to the set of keyword(s) in one or more contexts, which can be used to retrieve one or more, including potentially all, data sources in the group(s) of data sources associated with the context(s). Each context may be indexed by each keyword in the set of keyword(s) for easy retrieval based on keywords.

In some cases, the retrieved data sources will comprise one or more source objects. It should be understood that, when source objects are being ingested during training in subprocess 230, the keyword function (e.g., getKeywords( )), in any source object that implements the AI-supporting interface, will be encountered and parsed. In particular, the list of keywords that is returned by the keyword function will be ingested. Thus, source objects may be grouped and associated with contexts based on one or more, and potentially but not necessarily all, of the keywords in this list of keywords defined in the AI-supporting interface. Accordingly, the AI-supporting interface can benefit AI model 116 in both the training phase and the operating phase.

As discussed elsewhere herein, during training in subprocess 230, the training may detect when any of the ingested source objects implements the AI-supporting interface. Each source object that implements the AI-supporting interface may be flagged, using a parameter (e.g., Boolean parameter), such that, during the operating phase, the source object can be easily identified as implementing the AI-supporting interface, so that the corresponding response data can be retrieved from the AI-supporting interface, as described above with respect to the first embodiment. Alternatively, in the second embodiment, for any source object that is detected as implementing the AI-supporting interface, the response data may pre-acquired by calling the query function (e.g., query( )) for all permutations of the list of keywords returned by the keyword function. Each of these alternatives has its own advantages and disadvantages, as described elsewhere herein.

Training in subprocess 230 may also comprise an evaluation of AI model 116. Any one or more metrics may be used to evaluate AI model 116. In particular, the performance of AI model 116 may be tested, to produce one or more performance metrics. These performance metric(s) may then be compared to respective thresholds to determine whether or not the performance of AI model 116 is satisfactory. If the performance of AI model 116 is not satisfactory, AI model 116 may be retrained. This evaluation and retraining loop may repeat until the performance of AI model 116 is satisfactory. After the performance of AI model 116 is determined to be satisfactory, training process 200 may proceed to subprocess 240.

In subprocess 240, AI model 116 may be deployed for a support bot implemented by server application 112. For example, trained AI model 116 may be deployed from a training or development environment to an operating or production environment. As an example, AI model 116 may be deployed with an application programming interface that is accessible to other services on platform 110 (e.g., in a microservices architecture). This deployment may involve making AI model 116 accessible to server application 112 or integrating AI model 116 into server application 112, for use by the support bot.

### 4. Operating Process

FIG. 3 illustrates an example operating process 300 for operating a support bot for a software application, in an operating phase, according to an embodiment. Operating process 300 may be implemented by server application 112 to employ an AI model 116 for a support bot, which may be provided by server application 112 through user interface 114. It should be understood that operating process 300 may be performed for one or more conversations (e.g., within a chat interface) between one or more users and the support bot, regarding a software application.

While operating process 300 is illustrated with a certain arrangement and ordering of subprocesses, operating process 300 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In subprocess 310, a user request may be received. For example, a user request, related to the software application being supported, may be received via user interface 114. In particular, a user may input the user request to the support bot, implemented by server application 112, via a chat interface (e.g., graphical chat box) in user interface 114. It should be understood that the user request may be input to the support bot either textually as a character string (e.g., via a textbox input in the chat box) or vocally as spoken word (e.g., via a microphone of user system 130). In the event that the user request is input vocally, user system 130 or server application 112 may convert the speech into text via any suitable speech-to-text engine. In either case, the user request may be expressed in natural language. Whenever a new user request is received (i.e., “Yes” in subprocess 310), operating process 300 may proceed to subprocess 320. Otherwise, operating process 300 may proceed to subprocess 340.

In subprocess 320, the user request, received in subprocess 310, is input to AI model 116. AI model 116 may comprise a generative AI model, such as a transformer in the GPT series, which is configured to receive a natural-language prompt. In this case, the user request may be input, as-is or within a predefined template, to AI model 116. Alternatively or additionally, the user request may be pre-processed prior to being input to AI model 116. For example, as discussed elsewhere herein, the user request may be parsed and/or otherwise analyzed to derive a set of one or more keywords using any suitable natural language processing. In this case, AI model 116 may comprise a rules-based logic that matches the derived set of keyword(s) to one or more contexts, identifies relevant data sources associated with those context(s), retrieves response data from each relevant data source, and determines a final response from the retrieved response data. In any case, AI model 116 is applied to the user request to produce a response. In the case that AI model 116 was trained on source objects that implement the AI-supporting interface, the response may be based on the output of one or more functions (e.g., the disclosed query function and/or keyword function) of the AI-supporting interface.

In subprocess 330, the response, output by AI model 116, may be output in response to the user request. For example, in an embodiment in which user interface 114 is graphical, the response may be displayed in the chat interface of user interface 114. In particular, the response may be displayed by the support bot as a response to the user request, for example, juxtaposed with (e.g., under) the user request. Alternatively, in an embodiment in which user interface 114 is audial or audiovisual, the response could be translated into speech by any suitable text-to-speech engine and output as audio (e.g., via a speaker of user system 130), or into an audiovisual presentation by a generative AI model and output as a video (e.g., via a display and speaker of user system 130), within the chat interface. In any case, the response may be expressed in natural language. In some cases, the users may not even know that artificial intelligence is being used, and may simply assume that they are conversing with a human support technician.

In subprocess 340, it is determined whether or not AI model 116 is to be undeployed. For example, undeployment may be performed in response to a user operation by an administrative user via an administrative version of user interface 114. AI model 116 may be undeployed when it is to be retired (e.g., replaced by a newer version or a different AI model 116) or retrained. When determining to undeploy AI model 116 (i.e., “Yes” in subprocess 340), operating process 300 may end. Otherwise, when determining not to undeploy AI model 116 (i.e., “No” in subprocess 340), operating process 300 may return to subprocess 310 to await the next user request.

It should be understood that a plurality of users may converse with the support bot simultaneously. In this case, each user may converse with the same instance or a different instance of the support bot. For each conversation, the support bot may store context throughout the conversation, so that user requests and/or responses within the conversation can refer back to prior user requests and/or responses. Alternatively, conversations may be context-free.

### 5. Example AI Model

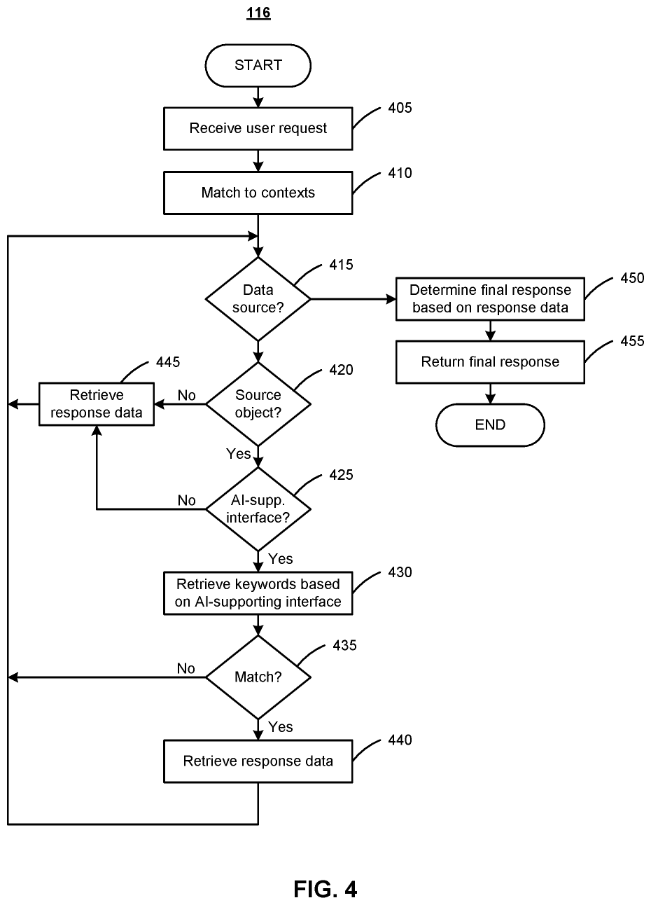

FIG. 4 illustrates AI model 116, according to an embodiment. While AI model 116 is illustrated with a certain arrangement and ordering of subprocesses, AI model 116 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In subprocess 405, the user request is received. It should be understood that subprocess 405 is the reception side of subprocess 320. In other words, AI model 116 is receiving the user request, received in subprocess 310 and input by subprocess 320 of operating process 300. The user request may simply be relayed, as-is, to AI model 116 (e.g., by server application 112), or may be pre-processed (e.g., by server application 112) prior to being input to AI model 116.

In subprocess 410, the user request may be matched to one or more contexts that were generated during training in subprocess 230 of training process 200. For example, keywords may be derived from the user request, as described elsewhere herein, and matched to keywords in the contexts, according to one or more matching criteria. Any suitable criteria may be used. If a plurality of contexts match the user request, a predefined number of contexts with the highest matching confidence or all contexts with a matching confidence that satisfies (e.g., equal to or greater than) a predefined threshold, may be selected. For each matched context, one or more, and preferably all, data sources associated with that context may be identified and/or retrieved (e.g., from database 118). If the user request does not match any contexts, an error or other response (e.g., prompting the user to restate the request, notifying the user that the request cannot be answered, suggesting that the user contact a customer support representative, etc.) may be provided to the user.

In subprocess 415, it is determined whether or not any of the identified data sources remain to be considered. In particular, AI model 116 may iterate through each data source that was identified and/or retrieved in subprocess 410. In a preferred embodiment, these iterations are performed in parallel as much as possible (e.g., within a computational budget). Alternatively, all of the iterations may be performed serially. When another data source remains to be considered (i.e., “Yes” in subprocess 415), the next data source is retrieved, and AI model 116 proceeds to subprocess 420. Otherwise, when no more data sources remain to be considered (i.e., “No” in subprocess 415), AI model 116 proceeds to subprocess 450.

In subprocess 420, it is determined whether or not the data source comprises a source object. In particular, AI model 116 may detect whether or not the data source comprises or consists of a source object based on one or more parameters (e.g., a Boolean value) associated with the data source. When the data source comprises a source object (i.e., “Yes” in subprocess 420), AI model 116 proceeds to subprocess 425. Otherwise, when the data source does not comprise a source object (i.e., “No” in subprocess 420), AI model 116 proceeds to subprocess 445.

In subprocess 425, it is determined whether or not the source object implements the AI-supporting interface. AI model 116 may determine whether or not the source object implements the AI-supporting interface from the training in subprocess 230 of training process 200. In particular, this may be one of the parameters (e.g., Boolean value) captured for each source object, as discussed elsewhere herein. When determining that the source object implements the AI-supporting interface (i.e., “Yes” in subprocess 425), AI model proceeds to subprocess 430. Otherwise, when determining that the source object does not implement the AI-supporting interface (i.e., “No” in subprocess 425), AI model may proceed to subprocess 445.

In subprocess 430, one or more keywords, associated with the source object, are retrieved. In the first embodiment described herein, these keyword(s) are retrieved through the AI-supporting interface. For example, AI model 116 may call the keyword function (e.g., getKeywords( )) of the source object's implementation of the AI-supporting interface. AI model 116 knows that the source object contains such a function, since the source object implements the AI-supporting interface, which requires that this function be implemented. In response, the keyword function will return a list of keywords that are relevant to the source object. Notably, the keyword function of the AI-supporting interface may be defined as a static method, such that it can be called without having to instantiate the source object. In the second embodiment described herein, these keyword(s) may be retrieved as the permutations of keywords, generated based on the list of keywords returned by the keyword function during training in subprocess 230 of training process 200.

In subprocess 435, it is determined whether or not the source object matches the user request, received in subprocess 405. In particular, the keyword(s) retrieved in subprocess 430, and associated with the source object, may be compared to keyword(s) derived from the user request to determine a relevance of the source object to the user request, according to one or more criteria. Any suitable criteria may be used. In the first embodiment, the keyword(s) derived from the user request are compared to the list of keywords returned by the keyword function of the source object's implementation of the AI-supporting interface. In the second embodiment, the keyword(s) derived from the user request are compared to each permutation of keywords, to determine whether any permutation of keywords matches the user request. If at least one keyword permutation matches the user request, then it is determined that the source object matches the user request. If a plurality of different keyword permutations match the user request, the keyword permutation that matches with the highest confidence may be selected as the matching keyword permutation. When determining that the source object matches the user request (i.e., “Yes” in subprocess 435), AI model 116 may proceed to subprocess 440. Otherwise, when determining that the source object does not match the user request (i.e., “No” in subprocess 435), AI model 116 may return to subprocess 415 to determine whether or not another data source remains to be considered.

In subprocess 440, the response data are retrieved. In the first embodiment, the response data is queried from the source object through the implemented AI-supporting interface. For example, AI model 116 may call the query function (e.g., query( )) of the source object, using keyword(s) derived from the user request (e.g., parsed and/or inferred from the user request) and/or the list of keywords returned by the keyword function (e.g., an intersection of the keywords derived from the user request and the list of keywords) as the input parameter. AI model 116 knows that the source object contains the query function, since the source object implements the AI-supporting interface, which requires that this function be implemented. In response, the query function will return response data. Notably, the query function of the AI-supporting interface may be defined as a static method, such that it can be called without instantiating the source object. In the second embodiment, the pre-generated response data associated with the keyword permutation that was matched in subprocess 430 is retrieved. In either case, the response data may comprise a full response to the user request, expressed, for example, in natural language.

In subprocess 445, the response data are retrieved. In this case, the data source either does not comprise a source object or comprises a source object that does not implement the AI-supporting interface. The response data may be retrieved in any suitable manner, including using conventional processes for obtaining response data from structured and/or unstructured data. In the event that the data source comprises or consists of a source object, the response data could be extracted from the source object based on functions, variables, comments, annotations, and/or the like, within the source code of the source object.

In subprocess 450, a final response is determined based on all of the response data retrieved in iterations of subprocesses 440 and/or 445. In an embodiment, each of the response data represent a candidate for the final response. AI model 116 may determine one of the response data to select as the final response, for example, by ranking all of the response data, according to one or more suitable criteria (e.g., confidence), and selecting the highest ranked response data.

Alternatively, AI model 116 may combine or aggregate two or more, including potentially all, of the response data into a final response. As an example, the response data may be combined into a natural-language prompt (e.g., using a template) that requests a generative AI model of AI model 116 to generate a response to the user request based on all of the retrieved response data. The generative AI model may be a large language model, such as one of the GPT series of transformers (e.g., GPT-4). In response, the generative AI model will return a natural-language response, which may be used as the final response. In an embodiment, subprocess 450 could incorporate a try/retry/failback mechanism to retry inputting the prompt when one or more defects in the response are detected, for a predefined number of times before executing a failback mechanism. It should be understood that a generative AI model is simply one example, and that other types of models, including deterministic logic, may be used to aggregate response data into the final response.

In subprocess 455, the final response is returned. It should be understood that subprocess 455 is the sending side of subprocess 330. In other words, AI model 116 is sending the final response that is received by subprocess 330. The final response may simply be output in subprocess 330 in the exact form in which it was received from AI model 116, or may be post-processed (e.g., by server application 112) prior to being output in subprocess 330.

In an embodiment, AI model 116 may be implemented with a control process and a plurality of worker processes. In this case, the control process may spawn a plurality of worker processes to retrieve response data from a plurality of data sources, including the source objects, in parallel. For example, a worker process could be spawned for each data source that is considered in subprocess 415. Each worker process then executes an iteration of subprocesses 420-445, and returns the retrieved response data to the control process. The control process then determines the final response based on the response data in subprocess 450, and outputs the final response in subprocess 455.

### 6. Example Processing System

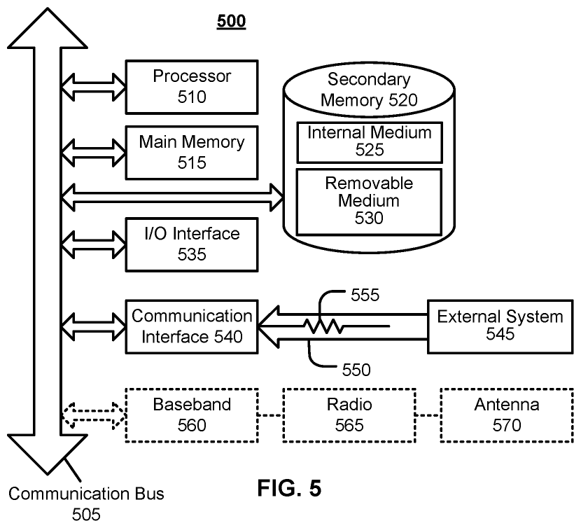

FIG. 5 illustrates an example processing system, by which one or more of the processes described herein may be executed, according to an embodiment. For example, system 500 may be used to store and/or execute software that implements processes 200 and/or 300 and/or AI model 116, and/or may represent components of platform 110, user system(s) 130, and/or other processing devices described herein. System 500 can be any processor-enabled device (e.g., server, personal computer, etc.) that is capable of wired or wireless data communication. Other processing systems and/or architectures may also be used, as will be clear to those skilled in the art.

System 500 may comprise one or more processors 510. Processor(s) 510 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 510. Examples of processors which may be used with system 500 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 510 may be connected to a communication bus 505. Communication bus 505 may include a data channel for facilitating information transfer between storage and other peripheral components of system 500. Furthermore, communication bus 505 may provide a set of signals used for communication with processor 510, including a data bus, address bus, and/or control bus (not shown). Communication bus 505 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 500 may comprise main memory 515. Main memory 515 provides storage of instructions and data for programs executing on processor 510, such as any of the software discussed herein. It should be understood that programs stored in the memory and executed by processor 510 may be written and/or compiled according to any suitable language, including without limitation C/C++, Java, JavaScript, Perl, Python, Visual Basic, .NET, and the like. Main memory 515 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 500 may comprise secondary memory 520. Secondary memory 520 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 500. The computer software stored on secondary memory 520 is read into main memory 515 for execution by processor 510. Secondary memory 520 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 520 may include an internal medium 525 and/or a removable medium 530. Internal medium 525 and removable medium 530 are read from and/or written to in any well-known manner. Internal medium 525 may comprise one or more hard disk drives, solid state drives, and/or the like. Removable storage medium 530 may be, for example, a magnetic tape drive, a compact disc (CD) drive, a digital versatile disc (DVD) drive, other optical drive, a flash memory drive, and/or the like.

System 500 may comprise an input/output (I/O) interface 535. I/O interface 535 provides an interface between one or more components of system 500 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 500 may comprise a communication interface 540. Communication interface 540 allows software to be transferred between system 500 and external devices, networks, or other information sources. For example, computer-executable code and/or data may be transferred to system 500 from a network server via communication interface 540. Examples of communication interface 540 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 500 with a network (e.g., network(s) 120) or another computing device. Communication interface 540 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 540 is generally in the form of electrical communication signals 555. These signals 555 may be provided to communication interface 540 via a communication channel 550 between communication interface 540 and an external system 545. In an embodiment, communication channel 550 may be a wired or wireless network (e.g., network(s) 120), or any variety of other communication links. Communication channel 550 carries signals 555 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 515 and/or secondary memory 520. Computer-executable code can also be received from an external system 545 via communication interface 540 and stored in main memory 515 and/or secondary memory 520. Such computer-executable code, when executed, enables system 500 to perform the various functions of the disclosed embodiments as described elsewhere herein.

In an embodiment that is implemented using software, the software may be stored on a computer-readable medium and initially loaded into system 500 by way of removable medium 530, I/O interface 535, or communication interface 540. In such an embodiment, the software is loaded into system 500 in the form of electrical communication signals 555. The software, when executed by processor 510, preferably causes processor 510 to perform one or more of the processes and functions described elsewhere herein.

System 500 may optionally comprise wireless communication components that facilitate wireless communication over a voice network and/or a data network (e.g., in the case of user system 130). The wireless communication components comprise an antenna system 570, a radio system 565, and a baseband system 560. In system 500, radio frequency (RF) signals are transmitted and received over the air by antenna system 570 under the management of radio system 565.

In an embodiment, antenna system 570 may comprise one or more antennae and one or more multiplexors (not shown) that perform a switching function to provide antenna system 570 with transmit and receive signal paths. In the receive path, received RF signals can be coupled from a multiplexor to a low noise amplifier (not shown) that amplifies the received RF signal and sends the amplified signal to radio system 565.

In an alternative embodiment, radio system 565 may comprise one or more radios that are configured to communicate over various frequencies. In an embodiment, radio system 565 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 565 to baseband system 560.

If the received signal contains audio information, then baseband system 560 decodes the signal and converts it to an analog signal. Then the signal is amplified and sent to a speaker. Baseband system 560 also receives analog audio signals from a microphone. These analog audio signals are converted to digital signals and encoded by baseband system 560. Baseband system 560 also encodes the digital signals for transmission and generates a baseband transmit audio signal that is routed to the modulator portion of radio system 565. The modulator mixes the baseband transmit audio signal with an RF carrier signal, generating an RF transmit signal that is routed to antenna system 570 and may pass through a power amplifier (not shown). The power amplifier amplifies the RF transmit signal and routes it to antenna system 570, where the signal is switched to the antenna port for transmission.

Baseband system 560 is communicatively coupled with processor(s) 510, which have access to memory 515 and 520. Thus, software can be received from baseband processor 560 and stored in main memory 510 or in secondary memory 520, or executed upon receipt. Such software, when executed, can enable system 500 to perform the various functions of the disclosed embodiments.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
during a training phase, train an artificial intelligence (AI) model on a training dataset, wherein the training dataset comprises source code for one or more source objects of a software application, wherein at least one of the one or more source objects implements an AI-supporting interface, and wherein the training detects when any of the one or more source objects implements the AI-supporting interface;
deploy the trained AI model in a support bot for the software application; and
during an operating phase,
receive one or more user requests, related to the software application, via a chat interface, and
for each of the one or more user requests,
input the user request to the AI model to produce a response from the AI model, wherein the response is based on an output of one or more functions of the AI-supporting interface of the at least one source object, and
output the response via the chat interface.

2. The method of claim 1, wherein the software application comprises an integration process or an element within an integration process.

3. The method of claim 1, wherein the one or more functions of the AI-supporting interface comprise a query function that receives a set of one or more keywords as input, and returns response data.

4. The method of claim 3, wherein the response data comprise a natural-language response string.

5. The method of claim 3, wherein the one or more functions of the AI-supporting interface comprise a keyword function that returns a list of keywords.

6. The method of claim 5, wherein the query function generates different response data for different permutations of keywords in the list of keywords.

7. The method of claim 5, wherein, during the operating phase, the AI model, for at least one of the one or more user requests:
calls the keyword function to acquire the list of keywords;
determines a query comprising one or more keywords in the list of keywords; and
calls the query function, using the query as the input to the query function, to acquire the response data;
wherein the response is based on the response data.

8. The method of claim 5, wherein, during the training phase, the training:
calls the keyword function to acquire the list of keywords; and
for each possible permutation of one or more keywords in the list of keywords,
calls the query function, using the permutation as the input to the query function, to acquire the response data, and
stores the response data;
wherein the response is based on at least one of the stored response data.

9. The method of claim 1, wherein, during the operating phase, for each of the one or more requests, the AI model:
receives the user request;
derives a set of one or more keywords from the user request;
identifies one or more contexts based on the set of one or more keywords;
identifies one or more data sources associated with the identified one or more contexts, wherein the one or more data sources comprise the at least one source object;
retrieves response data from each of the one or more data sources, wherein the retrieved response data comprise the output of the one or more functions of the AI-supporting interface of the at least one source object; and
determines the response based on the retrieved response data.

10. The method of claim 9,
wherein the AI model comprises a control process that receives the user request, derives the set of one or more keywords, identifies the one or more contexts, identifies the one or more data sources, and determines the response, and
wherein the control process, for each of the one or more data sources, spawns a worker process to retrieve the response data from that data source, and return the retrieved response data to the control process.

11. The method of claim 9, wherein retrieving the response data from each of the one or more data sources comprises, for each of the one or more data sources:
determine whether or not the data source is a source object;
when determining that the data source is a source object, determine whether or not that source object implements the AI-supporting interface;
when determining that the data source is not a source object or does not implement the AI-supporting interface, retrieving the response data according to a first process; and
when determining that the data source is a source object and does implement the AI-supporting interface, retrieving the response data according to a second process that is different from the first process.

12. The method of claim 11, wherein the second process comprises:
calling a keyword function of the AI-supporting interface to acquire a list of keywords;
determining a query based on the list of keywords acquired from the keyword function and the set of one or more keywords derived from the user request; and
calling a query function of the AI-supporting interface, using the query as input to the query function, to acquire the response data.

13. The method of claim 11, wherein:
during the training phase, for each source object that implements the AI-supporting interface, the training comprises
calling a keyword function of the AI-supporting interface to acquire a list of keywords, and
for each possible permutation of one or more keywords in the list of keywords,
calling a query function, using the permutation as the input to the query function, to acquire response data, and
storing the response data in association with the permutation; and
during the operating phase, the second process comprises
determining a permutation that matches the set of one or more keywords derived from the user request, and
retrieving the response data associated with that permutation.

14. The method of claim 1, wherein the user request and the response are expressed in natural language.

15. The method of claim 1, wherein the training comprises unsupervised learning.

16. The method of claim 15, wherein the unsupervised learning comprises clustering data sources, including the source code for the one or more source objects, into groups.

17. The method of claim 16, wherein the training further comprises associating each of the groups with a respective context.

18. The method of claim 17, wherein each respective context comprises one or more keywords.

19. A system comprising:
at least one hardware processor; and
software that is configured to, when executed by the at least one hardware processor,
during a training phase, train an artificial intelligence (AI) model on a training dataset, wherein the training dataset comprises source code for one or more source objects of a software application, wherein at least one of the one or more source objects implements an AI-supporting interface, and wherein the training detects when any of the one or more source objects implements the AI-supporting interface,
deploy the trained AI model in a support bot for the software application, and
during an operating phase,
receive one or more user requests, related to the software application, via a chat interface, and
for each of the one or more user requests,
input the user request to the AI model to produce a response from the AI model, wherein the response is based on an output of one or more functions of the AI-supporting interface of the at least one source object, and
output the response via the chat interface.

20. A non-transitory computer-readable medium having instructions stored therein, wherein the instructions, when executed by a processor, cause the processor to:
during a training phase, train an artificial intelligence (AI) model on a training dataset, wherein the training dataset comprises source code for one or more source objects of a software application, wherein at least one of the one or more source objects implements an AI-supporting interface, and wherein the training detects when any of the one or more source objects implements the AI-supporting interface;
deploy the trained AI model in a support bot for the software application; and
during an operating phase,
receive one or more user requests, related to the software application, via a chat interface, and
for each of the one or more user requests,
input the user request to the AI model to produce a response from the AI model, wherein the response is based on an output of one or more functions of the AI-supporting interface of the at least one source object, and
output the response via the chat interface.
